(19) United States
(12) Patent Application Publication
(10) Pub. No.: US 2017/0318200 A1
(43) Pub. Date: Nov. 2, 2017

(54) ELECTRONIC DEVICE SUCH AS A WIRELESS SECURITY CAMERA HAVING WALL-MOUNTED AND STAND-ALONE MODES

(71) Applicants: Brian Cox, Campbell, CA (US); Robert Chong, Hermosa Beach, CA (US)

(72) Inventors: Brian Cox, Campbell, CA (US); Robert Chong, Hermosa Beach, CA (US)

(21) Appl. No.: 15/582,326

(22) Filed: Apr. 28, 2017

Related U.S. Application Data
(63) Continuation of application No. 15/362,221, filed on Nov. 28, 2016, now abandoned.
Application No. 15/362,221 is a continuation of application No. 15/142,155, filed on Apr. 29, 2016, now abandoned.

(51) Int. Cl. H04N 5/225; H04N 7/18; H04N 5/232; H02J 7/02

(52) U.S. Cl. CPC H04N 5/2252; H04N 7/183; H04N 5/23296; H04N 5/2257; H02J 7/02

(57) ABSTRACT

A wireless security camera has both a wall-mounted mode and a standalone mode. In wall-mounted mode, the camera is much more unobtrusive than prior cameras. In standalone mode, the camera is aesthetically pleasing and does not look out of place.

### BACKGROUND

The present invention relates to electronic devices including wireless security cameras. Wireless security cameras are known.

### SUMMARY

Unlike prior cameras and other electronic devices, the present camera has both a recessed, wall-mounted or ceiling-mounted installation mode and a standalone installation mode. Herein, “wall-mounted” is used to refer to both wall-mounted and ceiling-mounted. In wall-mounted mode, the camera is much more unobtrusive than prior cameras. In standalone mode, the camera is aesthetically pleasing and does not look out of place. A modular design is well-suited to other electronic devices, such as lights, speakers, etc.

In the past, magnetic attachment has primarily been used for connectors. The magnetic attachment mechanism described, however, provides for magnetic attachment of functional modules that simultaneously achieves both mechanical and electrical connection. The same principle may be used regardless of what the particular modules may be. Although in the described exemplary application one of the modules is a battery module, that need not be the case.

Note further that the present magnetic attachment mechanism allows the mechanical orientation of the modules to be finely and continuously adjustable. Such adjustability could normally be achieved only through more complex mechanical means. These features in combination result in great ease of installation and use. The ease of installation makes “do-it-yourself” installation within the level of skill of most users.

The same features also enable superior aesthetics to be achieved. In the case of a “ball and socket” type connection as described, the socket may be recessed in a ceiling, wall or other surface. As a result, when the electronic module is inserted, a flush-mount effect is achieved.

This more discreet appearance is not only aesthetically pleasing but, in the case of cameras, alleviate potential unease on the part of guests. For intruders, the camera presents a less conspicuous potential target for tampering or disablement.

### BRIEF DESCRIPTION OF THE DRAWING

The present invention may be further understood from the following description in conjunction with the appended drawing figures. In the drawing:

FIG. 1A is a perspective view of the present camera in a standalone configuration.

FIG. 1B is a perspective view of the present camera in a flush mount configuration.

FIG. 1C is a perspective view of the present camera in a wall integration configuration.

FIG. 2A is a diagram of an installation step for wall integration.

FIG. 2B is a diagram of a further installation step for wall integration.

FIG. 2C is a diagram of a further installation step for wall integration.

FIG. 2D is a diagram of a further installation step for wall integration.

FIG. 2E is a diagram of a further installation step for wall integration.

FIG. 2F is a diagram of a further installation step for wall integration.

FIG. 3 is a diagram illustrating registration and setup.

FIG. 4A is an example of a user interface display.

FIG. 4B is an example of another user interface display.

FIG. 5 is a diagram illustrating application flow.

FIG. 6A is a sectional view of the camera in a wall integration configuration.

FIG. 6B is a sectional view of the camera in a standalone configuration.

FIG. 7A is a diagram of showing details of a pivoting magnetic power attach mechanism prior to attachment.

FIG. 7B is a diagram of showing details of a pivoting magnetic power attach mechanism following attachment.

FIG. 8 is a partial cut-away view of the camera in a wall integration configuration.

FIG. 9 is a partial cut-away view of the camera in a wall integration configuration.

FIG. 10 is a diagram of an alternative wall-mount embodiment.

FIG. 11 is a cross-sectional view of a wall-mounted camera installation in accordance with another embodiment.

FIG. 12A is a cross-sectional view of receiving member in accordance with another embodiment.

FIG. 12B is a perspective view of a power module in accordance with another embodiment.

FIG. 13A is a cross-sectional view of another alternative mounting mechanism.

FIG. 13B is a cross-sectional view of another alternative mounting mechanism at a different stage of insertion of a combined battery module and camera module.

FIG. 13C is a cross-sectional view of another alternative mounting mechanism at a different stage of insertion of the combined battery module and camera module.

FIG. 13D is a cross-sectional view of another alternative mounting mechanism at a different stage of insertion of the combined battery module and camera module.

FIG. 13E is a cross-sectional view of another alternative mounting mechanism at a different stage of insertion of the combined battery module and camera module.

FIG. 13F is a cross-sectional view of another alternative mounting mechanism at a final stage of insertion of the combined battery module and camera module.

FIG. 14 is a block diagram of the present cloud-based camera system.

### DETAILED DESCRIPTION

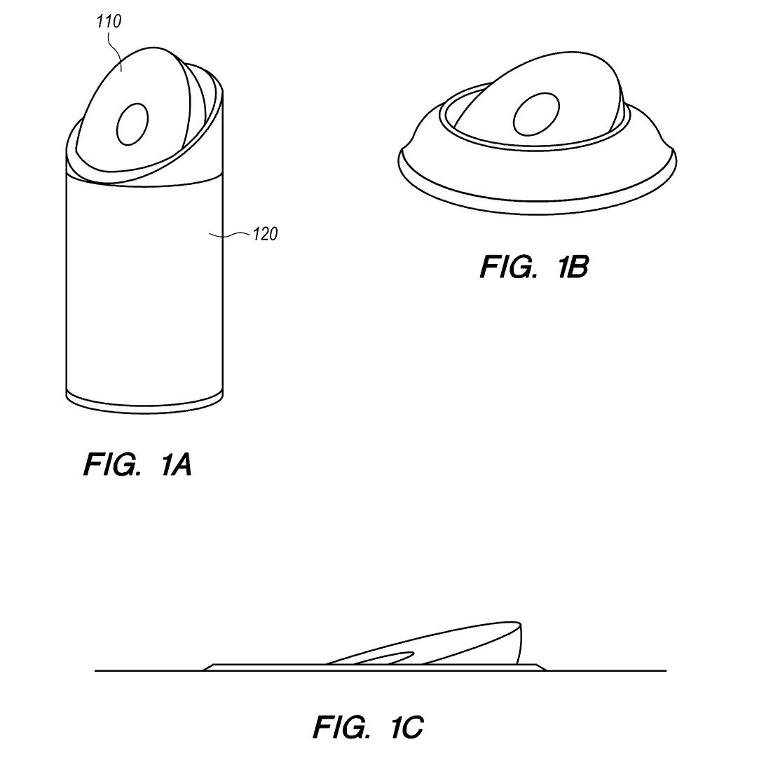

Referring to FIG. 1A, a perspective view of the present camera is shown. The camera is provided with a camera module 110 and a rechargeable battery module 120 that powers the camera for an extended period, for example up to one year. In one embodiment, the camera is connected to the cloud, and video is stored in the cloud. As used herein, “cloud” refers to network elements that enable provider-rendered services An app (application), such as a smartphone app or the like, may be used to interface with the camera and with the cloud. Different wall-mount configurations of the camera are shown in FIG. 1B and FIG. 1C, respectively. Note that, although the camera is shown as being generally cylindrical in design, the camera may take any of a variety of different possible shapes and designs.

In one embodiment, the camera may be installed in a wall or ceiling as follows:

1. Download the smartphone app and boot it up to follow the installation guide.

2. Plug the power module into the wall charging unit to fully charge the device before installation.

3. Choose location on wall/ceiling for installation. Verify the location behind the drywall is clear of any studs, electrical wiring, plumbing, or other object.

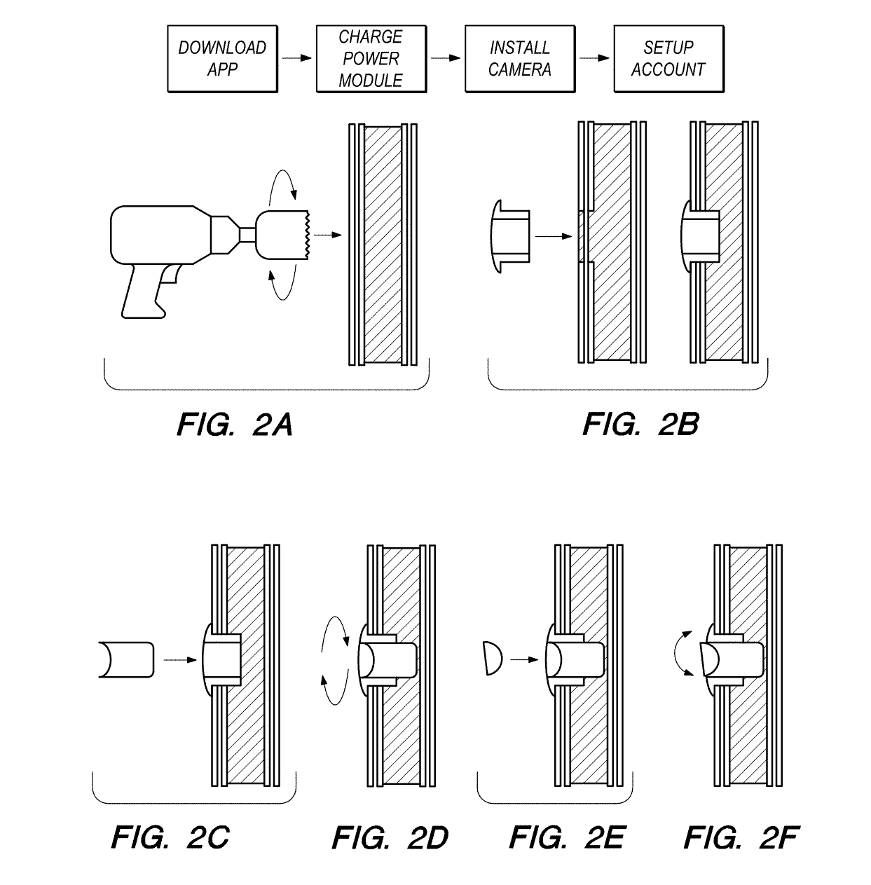

4. Attach hole saw (e.g., 3″ diameter) to power drill and cut hole in wall to a specified minimum depth (e.g., 3.75″) from outer surface of drywall (FIG. 2A).

5. If a drywall collar is used, insert the drywall collar by pressing into the wall by hand until outer flange sits flush against wall (FIG. 2B). In other embodiments, a drywall collar may not be necessary.

6. Once the power module is fully charged, attach the wall-mount interface to the power module by screwing the interface module on clockwise (FIG. 2C). In other embodiments, the wall-mount interface may snap in place, or be secured in any of other various means, instead of by screwing.

7. Insert the power module into the drywall collar as shown in diagram (FIG. 2D). Secure the power module by screwing the power module into the drywall collar until it bottoms out. Do not over-torque the power module. Hand tight is sufficient to hold the device in place.

8. Insert the camera module into the drywall collar assembly with the flat surface with lens facing out (FIG. 2E). The magnet will catch the camera and hold it in place. Swivel and twist the camera module to the desired position (FIG. 2F). You can fine tune the position later on.

9. Turn your smartphone Bluetooth on. Pair the camera and app via the Bluetooth pairing effort.

10. Complete registration and setup process via the app. Open up live view mode on the app and fine tune the camera position as needed.

Note that the installation is a simple “do it yourself” effort as a result of the use of batteries. In wall-mounted mode, the camera is much more unobtrusive than prior cameras.

The camera may also be installed in standalone mode, as follows:

1. Download the smartphone app and boot it up to follow the installation guide.

2. Plug the power module into the wall charging unit to fully charge the device before installation.

3. Once the power module is fully charged, insert the power module into the standalone base.

4. Insert the camera module with the lens facing out. The magnet will catch the camera and hold it in place. Swivel and twist the camera module to the desired position. You can fine tune the position later on.

5. Turn your smartphone Bluetooth on. Pair the camera and app via the Bluetooth pairing effort.

6. Complete registration and setup process via the app. Open up live view mode on the app and fine tune the camera position as needed.

In standalone mode, the camera is aesthetically pleasing and does not look out of place.

In either of the foregoing modes, the user may choose to keep the device plugged into wall power using, for example, a micro USB cable and 5 W power adapter. Powering the camera in this manner is particularly useful for those users who are less concerned about the aesthetic and more concerned about having to charge batteries occasionally.

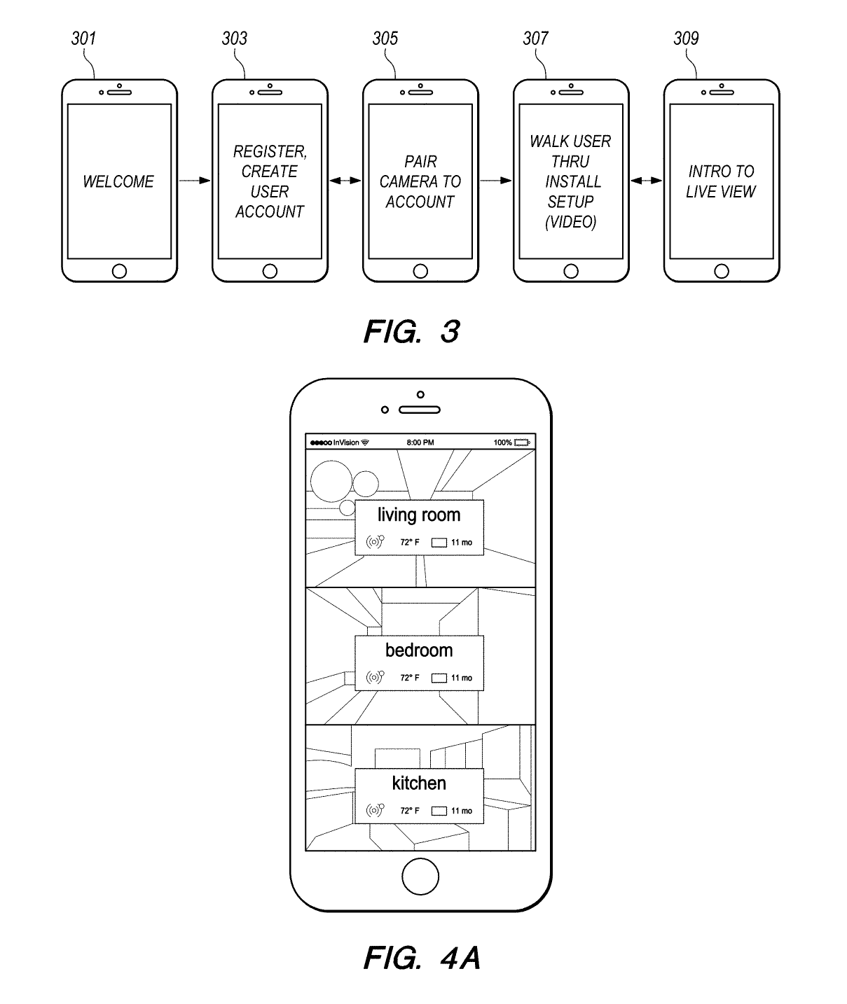

Various software features make the camera simple and easy to use. Referring to FIG. 3, a diagram of account setup and user registration is shown. At step 301, a welcome screen is displayed. At step 303, the user registers and creates a user account. At step 305, the camera is paired to the user account. At step 307, an installation video is displayed, showing the user how to install the camera. At step 309, an introduction to camera operation is displayed, including for example, “live view,” in which live video from one or multiple cameras is displayed.

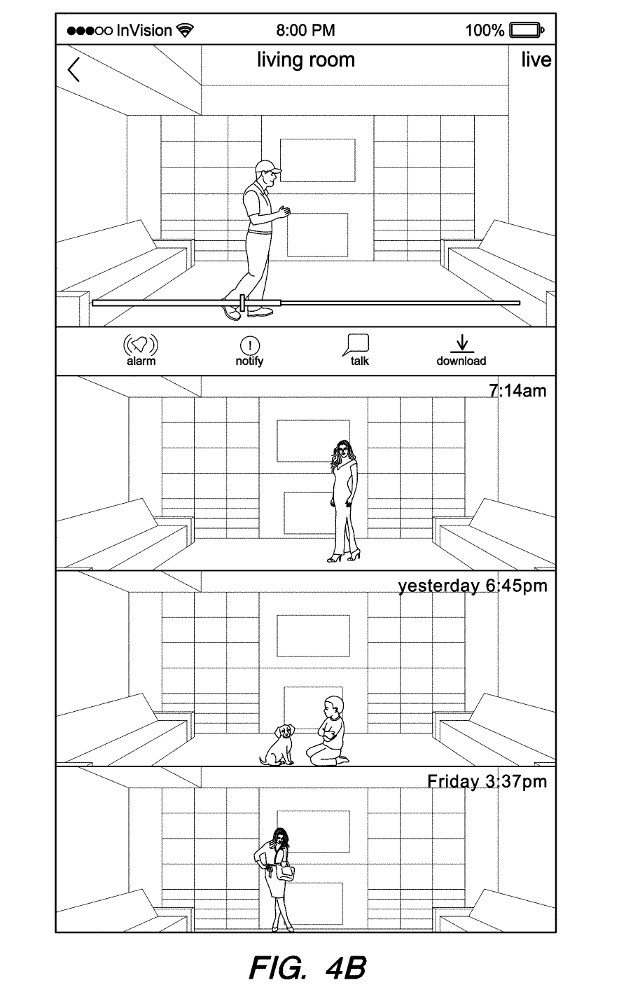

Referring to FIG. 4A, an example of a display in live view is shown, in which live camera feeds from camera installed in different rooms are shown. In the illustrated example, camera feeds are displayed for the living room, the bedroom and the kitchen.

Referring to FIG. 4B, a live feed of a selected room is shown at the top of the display view.

Underneath are displayed multiple “snapshots” of the same room at different points in time. In some embodiments, the user may be enabled to determine the times of the snapshots displayed, play recorded footage beginning at a time determined based on a snapshot, etc.

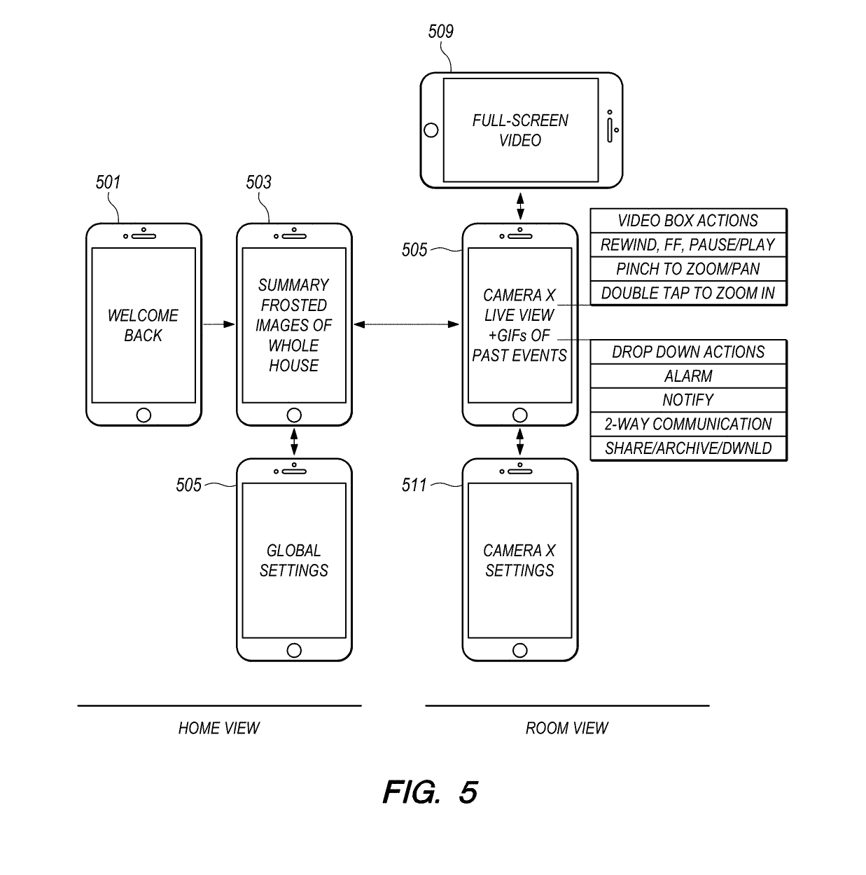

An example of one possible application flow is shown in FIG. 5. When the user, opens the app, a “welcome back” screen is displayed (501), followed by a home view in which summary images of the whole house are displayed (503). In home view, the user may use the app to change global settings (505). In room view, a particular room or camera is selected (e.g., “camera X.”). A live view from camera X is displayed, together with images (e.g., animated GIFs, or still images) of past events. Significant events may be detected in the cloud based, for example, on sound, image analysis, etc. In one embodiment, intelligent software enables the user to specify events according to the user's preferences, both to ensure that important events are not missed and that unimportant events are not displayed. The user may tilt the viewing device (e.g., smartphone) for more convenient viewing of full screen video (509). Also in room view, settings for camera X may be changed. The user may take various video box actions, examples of which may include rewind, fast forward, pause, play, zoom, pan, etc. The user may also take various drop down actions, for example to set up alarms and notifications, two-way audio communication (for viewers to verbally communicate with subjects under surveillance), to share, archive or download video, etc.

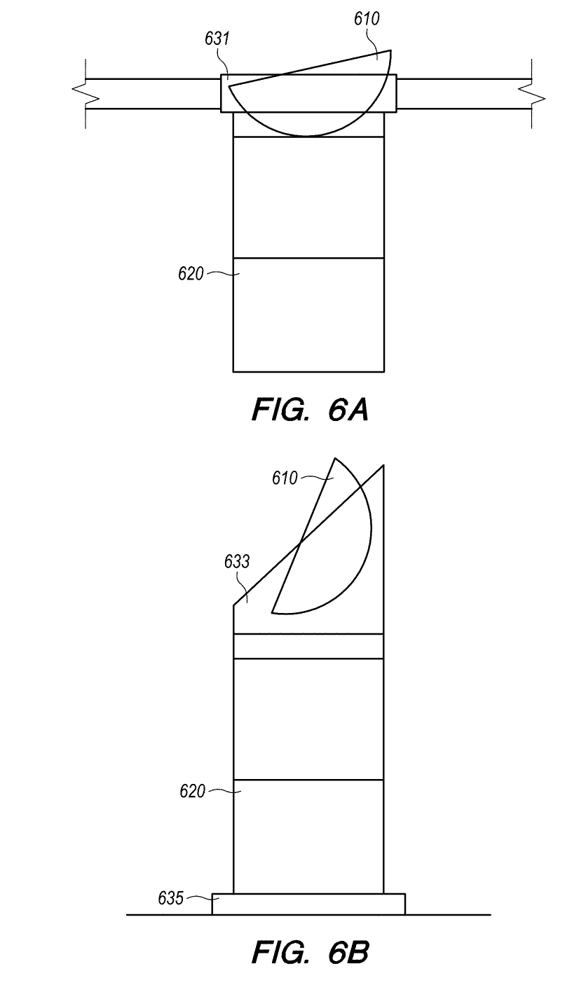

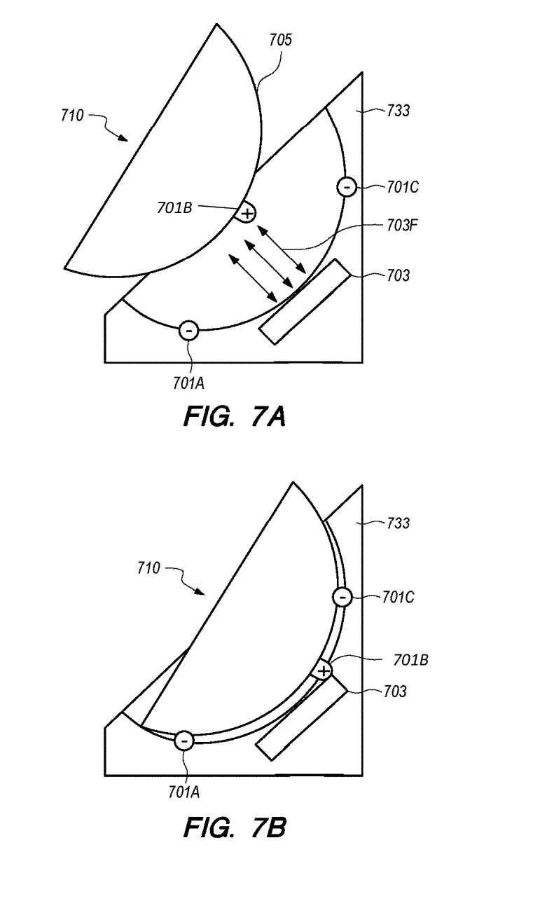

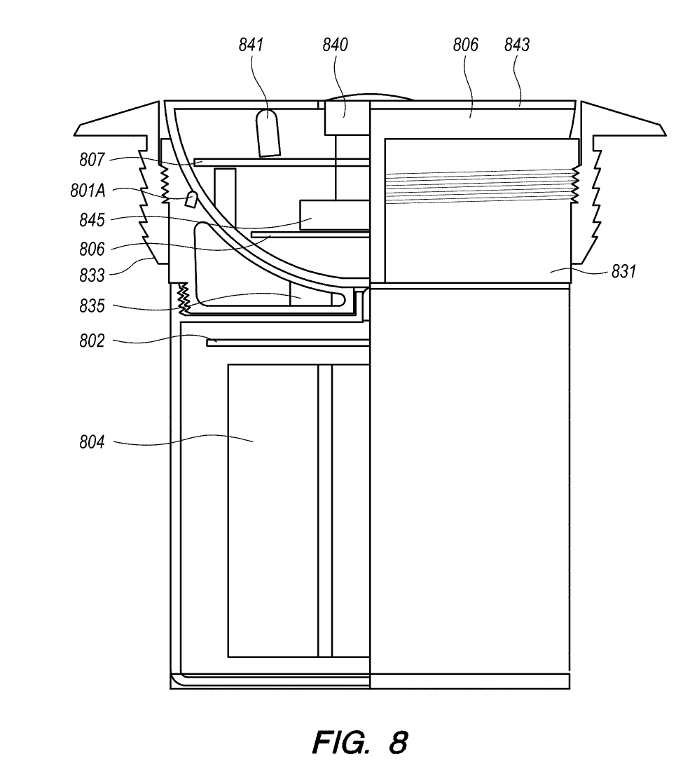

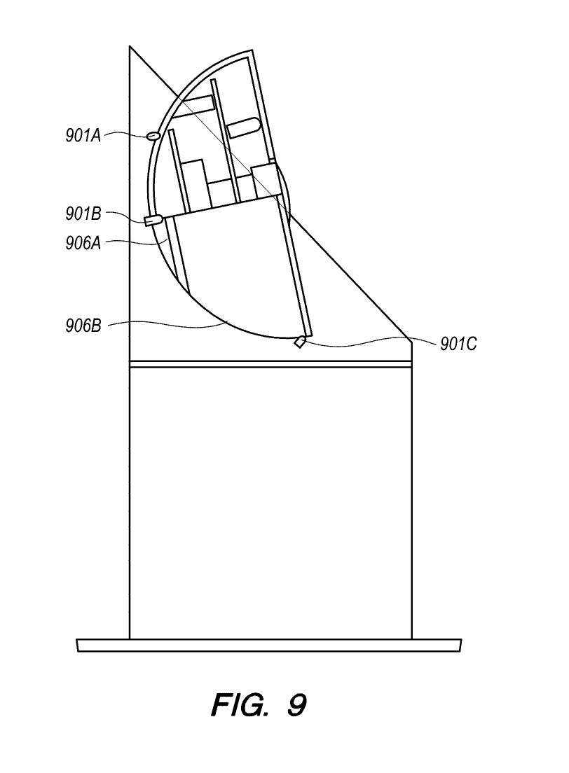

Further details of the camera hardware are shown in FIG. 6A, FIG. 6B, FIG. 7A, FIG. 7B, FIG. 8 and FIG. 9.

Referring to FIG. 6A, a cross-sectional view is shown of the camera in an in-wall configuration, using an in-wall interface module 631. The in-wall interface module 631 couples the camera module 610 to the battery module 620.

In FIG. 6B, a cross-sectional view is shown of the camera in a free-standing configuration, using a free-standing interface module 633 and a free-standing support base 635. The free-standing interface module 633 couples the camera module 610 to the battery module 620.

Referring to FIG. 7A and FIG. 7B, cross-sectional views are shown of the camera module 710 and the free-standing interface module 733 in a free-standing configuration. FIG. 7A shows the camera module 710 during insertion into the free-standing interface module. FIG. 7B shows the camera module after insertion.

In an exemplary embodiment, the camera module 710 has a hemispherical configuration, and the free-standing interface module 733 is configured so as to provide a matching socket that receives the camera module. Alternatively, the camera module may have a spherical configuration.

Attachment of the camera module 710 and the free-standing interface module is achieved using magnetic coupling, with a magnet 703 producing magnetic lines of flux 703F that exert a force of attraction on an internal steel attraction plate or dish (not shown) of the camera module 710. The attractive force may be such that the camera module 710 may still be adjusted to achieve a desired view. Positive and negative pogo-pin contacts 701A, 701B and 701C, in cooperation with a conductive member 705 of the camera 710, and another separate conductive area (not shown) in the pole region of the interface module 733, supply power to the camera module 710.

Referring to FIG. 8, a partial cut-away view of the camera in an in-wall configuration is shown, using the in-wall interface module 831. A camera lens 840 is situated in the center of the hemisphere of the camera module. In the illustrated embodiment, the in-wall interface module 831 attaches to a drywall anchor 833 using threaded engagement. Batteries 804 supply power to the camera in cooperation with a power board 802, a power pogo pin 801A and a conductive band 806, as previously described, and a magnet 835 provides for magnetic attachment, also as previously described. Instead of pogo pins, any of various other types of conductive springs or mediums may be used. In the illustrated embodiment, in addition to the power board 802, a camera board 806 and a main logic board 807 are provided. For night vision, the camera may be provided with IR capabilities, using an IR LED 841, an IR window 843 and an IR cut filter 845.

The camera may also be provided with a micro USB cable or similar charging port (not shown).

When doing surveillance with infrared, infrared light leads to color distortion during the day. Known day/night cameras feature an IR-cut filter which keeps the disturbing infrared light out of the image sensor during the day. When the light falls below a certain level, in terms of image contrast, the filter automatically swivels out of the way so that the infrared light does hit the image sensor. At the same time, the camera switches to black/white mode, in which it can use the infrared light optimally. In well-lit areas, the infrared lights may be turned off during the day and turned on in poor light or in darkness.

A similar partial cut-away view for free-standing mode is shown in FIG. 9. In this view, three separate power pogo pins, 901A, 901B and 901C may be seen, together with two separate conductive members, 906A and 906B.

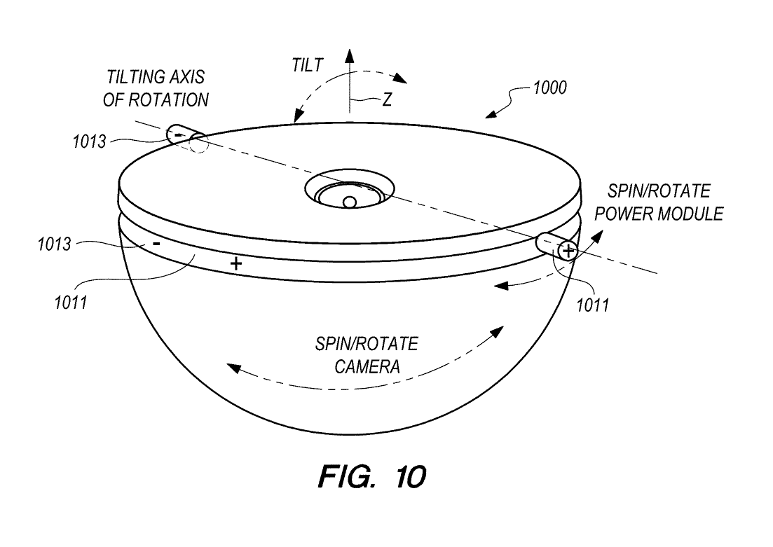

Supply of power from the battery module to the camera module may be accomplished in a variety of different ways. Referring to FIG. 10, in one alternative wall-mount embodiment, a camera module 1000 is supplied with power via pins 1011, 1013 coupled to the power module (not shown). The pins may be pogo pins or the like that achieve reliable, resilient contact. In the illustrated embodiment, a pin 1111 provides positive power supply, and a pin 1113 provides negative power supply. The camera module 1000 is provided with a power supply ring having, for example, a positive segment 1011 and a negative segment 1013.

Full Freedom of rotation may be achieved as follows. Consider the vertical direction in FIG. 10 to be the Z Axis as shown. The X axis coincides with an Axis between the power pins 1011 and 1013, and the Y axis (not shown) is perpendicular to the X and Z axes. The camera module 1000 may be rotated about the Z axis so to cause travel between the power supply ring of the camera module and the power supply pins 1011 And 1013. The camera module may be rotated about the X axis while the relative positions of the power supply ring and the power supply Pins remains the same. Finally, rotation about the Y axis may be achieved by rotation of both the camera and the power module, without any relative rotation between the two. Such rotation of the power module may be achieved, for example, in a manner similar to existing mounts for recessed lights.

Rotation about the Z axis may cause what is shown as the negative segment of the power ring to contact the positive power pin, and the positive segment to contact the negative power pin. Logic may be provided in the camera module to sense this polarity reversal and to perform a switching operation to account for the reversal.

The modularity of the design as described results in great flexibility. Camera modules may be replaced with other devices designed to operate off of the battery module power such as lights, a speaker etc. Additionally, the cameras can be replaced by the user separately from the battery module. Lower cost of repair and ability to upgrade cameras at a lower cost are two user benefits.

Because the camera is wireless and battery-powered, it allows for in-ceiling installation by the novice user. Such installation should be as simple as possible. In general, once a ceiling hole has been drilled, installation may be accomplished by first inserting into the hole a receiving part, followed by inserting into the receiving part a device part, and securing the two. The receiving part may be provided with multiple deformable members that, upon insertion of the device part, deform so as to contact an inner surface of the ceiling and retain the receiving part in position.

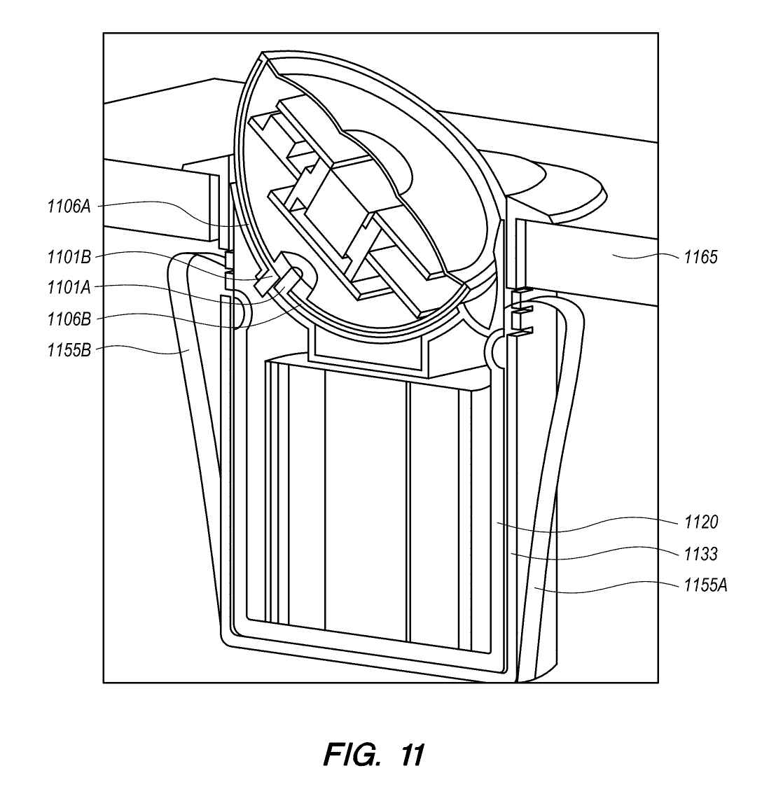

Referring to FIG. 11, a cross-sectional view is shown of a wall-mounted camera installation in accordance with another embodiment. A receiving member 1133 is provided (instead of simply a drywall collar) and is installed in a hole in ceiling material 1165. Spring members 1155A and 1155B may be provided to retain the receiving member 1133 in place or to assist in doing so. A battery module 1120 is inserted into the receiving member 1133. The battery module 1120 may rotate into place, thread into place, snap into place, etc.

Further details of a mating arrangement between the camera module and the power module, in accordance with one embodiment, are also shown in FIG. 11. A camera module 1110 attaches magnetically to the battery module 1120. Power to the camera module is provided by pogo pins 1101A, 1101B and conductive members 1106A and 1106B. The mating arrangement is particularly advantageous in that it allows for pitch, yaw, roll of camera with respect to mating base without loss of connection, without the need for wires, and offering simple installation/positioning/removal of the camera.

In one embodiment, the camera module's conductive member 1106A is a full hemisphere with a single hole in the bottom for the pogo pin 1101A to come through. In the image below, the camera's conductive surface is the high gloss part on the backside of the camera. The battery module's conductive member 1101B may be a partial or truncated hemisphere (concave). The same arrangement may be used for both a ceiling mounted version of the battery module and a tabletop version.

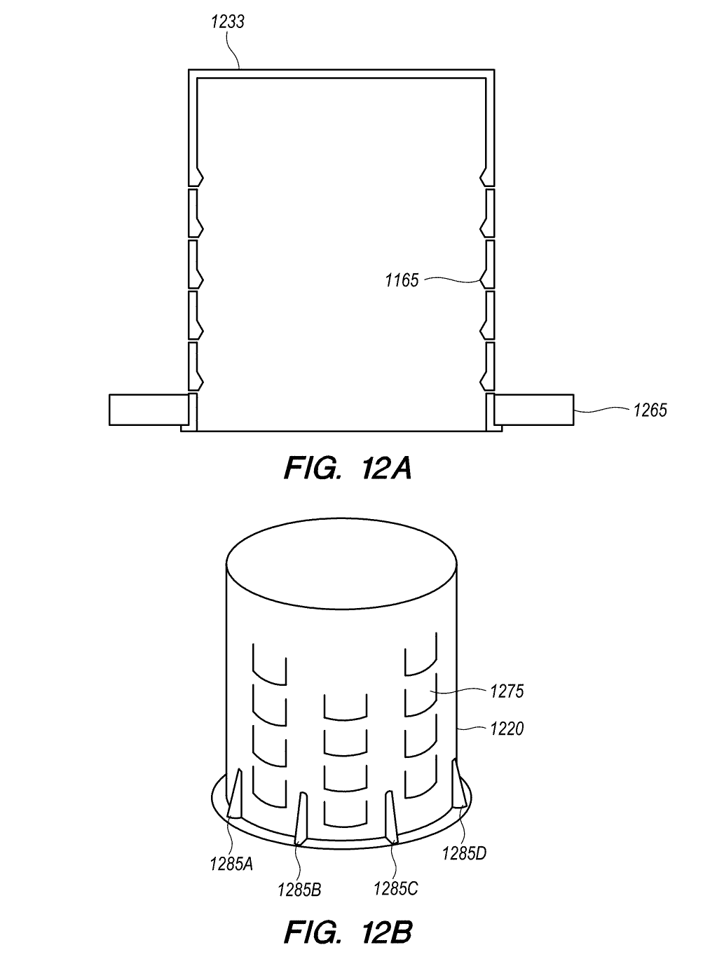

Various other receiving member and power module configurations may be provided to enable various different mounting arrangements. In accordance with FIG. 12A, a receiving member 1233 (mounted in ceiling 1265) is provided with an array of anchor teeth 1285. A corresponding power module 1220, shown in FIG. 12B, is provided with a corresponding array of raised lands 1275. Upon insertion of the power module 1230 into the receiving member 1233, the anchor teeth 1285 flare out as a the raised lands 1275 pass and then relax back inward. In a final position, an anchor tooth supports each of the raised lands in the array. A very reliable mounting mechanism results that requires only snap-in insertion. The power module 1220 may also be provided with anti-rotation gussets 1285 (FIG. 12B) that may be pressed into the ceiling material.

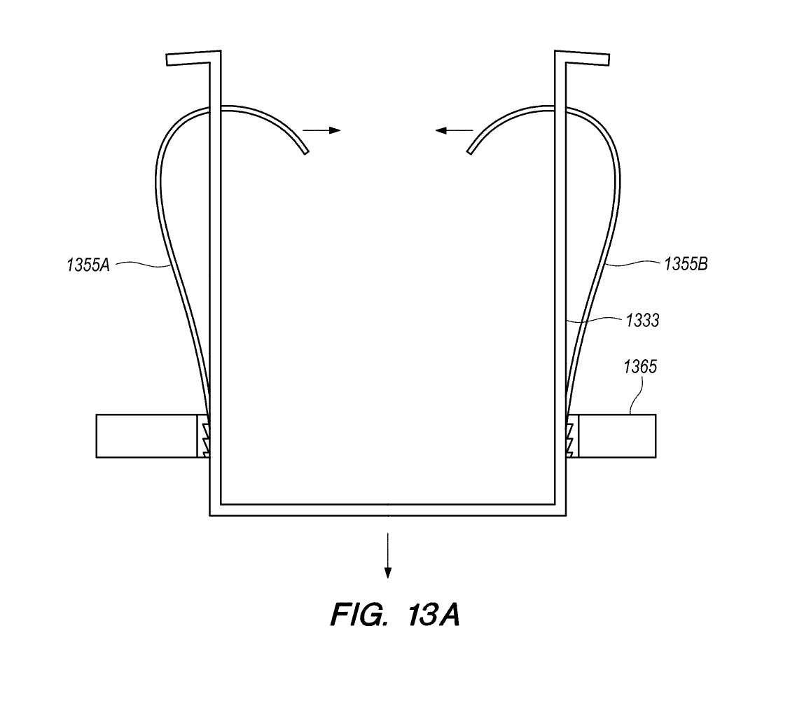

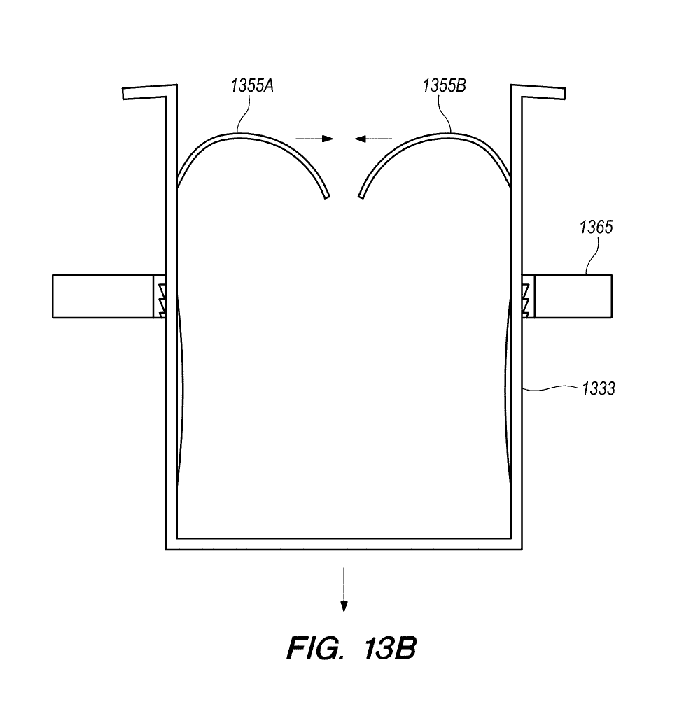

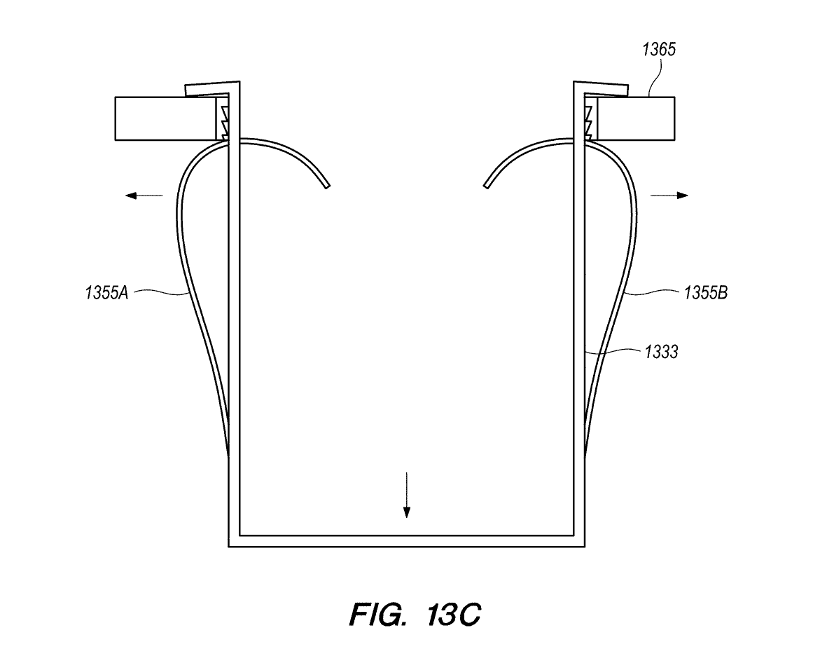

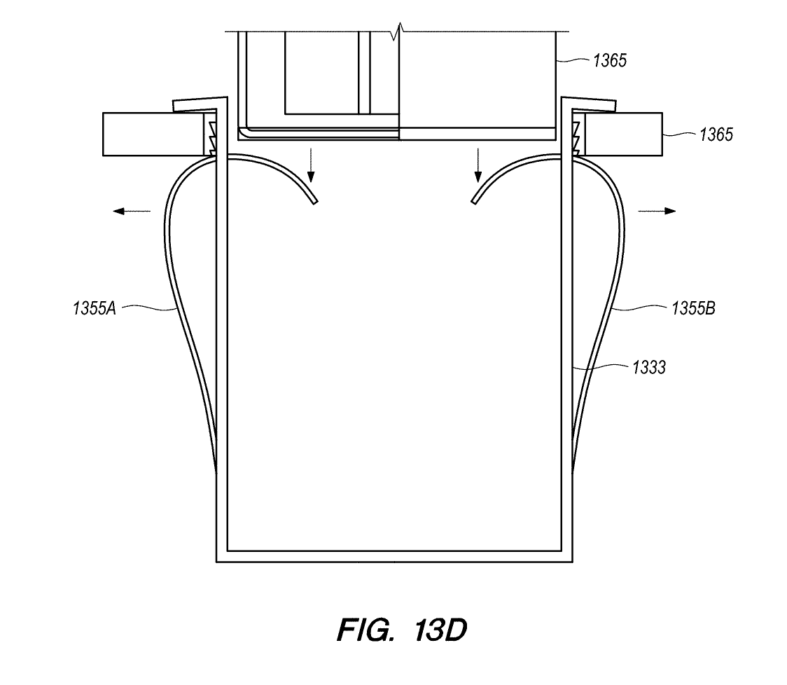

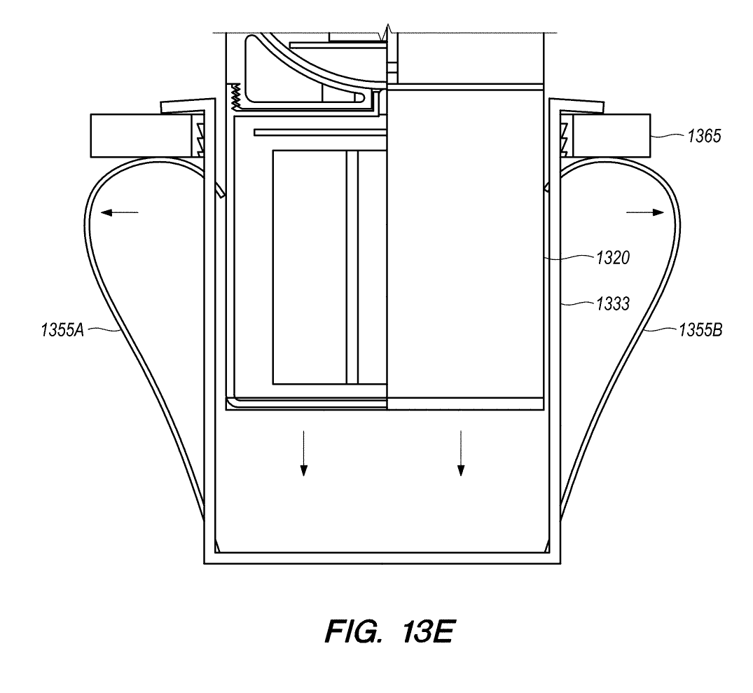

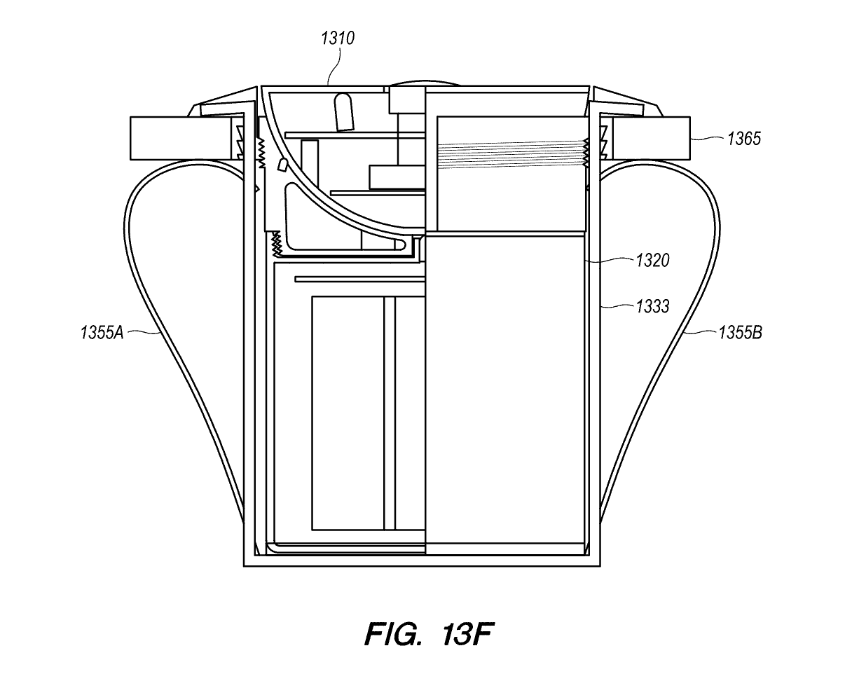

Referring to FIG. 13A through FIG. 13G, another alternative mounting mechanism is shown. As seen in FIG. 13A, a receiving module 1333 is provided with spring-like elements 1355A and 1355B. Also shown is a ceiling material 1365.

As seen in FIG. 13B, as the receiving module 1333 is progressively inserted into a hole in the ceiling material, the spring elements deform inward. As seen in FIG. 13C, when the receiving module has been fully inserted, the spring elements relax outwardly. Ends of the spring elements remaining extending inwardly within the receiving module. In FIG. 13D, insertion of the power supply module 1320 is begun. As insertion of the power supply module 1320 progresses (FIG. 13E, FIG. 13F), the spring elements are deflected outwardly. In a final position (FIG. 13F), the power supply module 1320 is fully inserted and the camera module 1310 is mated with the power supply module. The spring elements 1355A and 1355B are fully deflected outward and retain or assist to retain in place the receiving module 1333.

An important capability of the present system is to use video and other information to distinguish between authorized persons and unauthorized persons. To do so, the system attempts to recognize authorized persons and identifies all other persons as unauthorized. The presence of an unauthorized person may result in an alarm, an alert, automated control actions, etc.

In one embodiment, information other than video information is used to help identify authorized persons. This information may be obtained from a mobile electronic device carried by a person.

For example, various household members and visitors may each carry a mobile electronic device provided with an app that interfaces with the camera system (or simply with the internet). The mobile electronic device is queried to obtain information that establishes identity or that can be used in conjunction with video-derived information to help establish a higher confidence level of an identity.

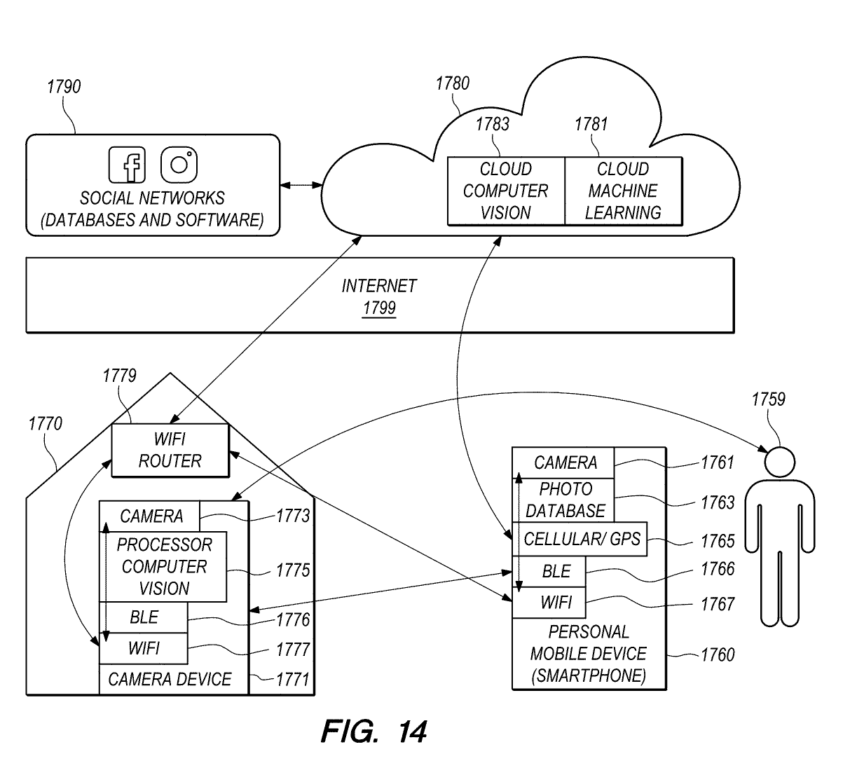

Referring to FIG. 14, a block diagram is shown of the present cloud-based camera system.

Within premises 1470 are located a camera device 1471 and a WiFi router 1479. The camera device may be constructed in accordance with the previous description and includes intercommunicating elements including a camera 1473, a computer vision processor 1475, and connectivity elements 1476 (Bluetooth Low Energy, or BLE) and 1477 (WiFi). The WiFi element 1477 communicates with the WiFi router 1470. (The computer vision processor 1475 may alternatively be located within cloud infrastructure 1480.) A user 1459 carries a personal mobile device (e.g., a smartphone) 1460. The device 1460 includes intercommunicating elements including a camera 1461, a photo database 1463, and connectivity elements 1465 (cellular/GPS), 1465 (Bluetooth Low Energy, or BLE) and 1467 (WiFi). The device 1460 may also be provided with an app that: 1) enables the user to interface with premises equipment including the camera device 1471 and the WiFi router 1479; and 2) enables the user to interface through the internet 1499 with cloud infrastructure 1480, including a cloud computer vision module 1481 and a cloud machine learning module 1483. The cloud infrastructure 1480 communicates with databases and software of various social networks, such as the Facebook™ social network.

When the user 1459 is within the premises 1470, video of the user is captured by the camera 1473. A task of the system is to determine whether the user 1459 is authorized to be within the premises or is an intruder. This determination may be performed by the cloud infrastructure, for example, using multiple sources of information. One source of information is the captured video itself. Facial recognition techniques may be applied in an attempt to identify the user 1459. In addition, the cloud infrastructure may use a “digital fingerprint” of the person 1459. Such digital fingerprint information may include, for example, location history of the device 1460 and may be obtained by the cloud infrastructure through the app on the device 1460, either on an as-needed basis or on a continuous basis as the person 1459 move between different locations. If facial recognition results are consistent with device locations patterns of an authorized user, then an increased level of confidence is achieved in identifying the person 1459 as an authorized person.

In case of inconsistency, various actions may be taken to attempt to identify the person as either authorized or unauthorized.

Access of the cloud infrastructure 1480 to social networks 1490 facilitates learning by the cloud machine learning module 1483 so that it increasingly capable of identifying authorized persons and hence (by elimination) unauthorized persons. For example, photos from social networks may be used to perform facial recognition with increased accuracy.

The foregoing system enables high-accuracy subject identification by leveraging not only computer vision (CV), but also the subject's connected devices (primarily smart phone) using BLE, WIFI, Cellular geolocation, and the subject's smartphone photo gallery or social network (Facebook/Instagram) database and CV (facial recognition software).

The foregoing system enables time-based patterns to be identified in the subject's location as determined by CV, mobile phone geolocation, WiFi location, and BLE visibility.

Through machine learning, the system establishes an assumed normal schedule and can identify outliers or abnormalities in behavior. If the CV software identifies a subject and the subject is present in a location that is aligned with normal behavior, then the confidence in the positive ID is increased. If the CV software identifies a subject but the location of the subject's mobile phone is a significant distance away from the camera which identified the subject, then confidence in the identification is reduced.

Through image capture, computer vision, and other location identification means, the software will add images to a running database in order to keep current the database of images that represent a subject. Through machine learning, the software is capable of becoming more accurate in its identification of a subject.

Through machine learning and pattern recognition, the software can automatically associate an image database of a subject with a specific mobile device identifier (such as a mac address) when the mobile device is found on the same WiFi network as the camera device or when the camera device discovers said mobile device over Bluetooth Low Energy (BLE) or when the geolocation of said mobile device is determined to be located nearby the location or address where the camera device has been installed.

It will be appreciated by those skilled in the art that the present invention may be embodied in other specific forms without departing from the spirit or essential character thereof. The foregoing description is therefore considered in all respects to be illustrative and not restrictive.

The scope of the invention is indicated by the appended claims, not the foregoing description, and all changes that come within the scope and range of equivalents thereof are intended to be embraced therein.

What is claimed is:

1. An apparatus comprising:
a wireless electronic module;
a battery module; and
a magnetic coupling for coupling together the wireless electronic module and the battery module to attach the wireless electronic module to the battery module and to provide power to the wireless electronic module;
wherein the magnetic coupling is configured to enable an orientation of the wireless electronic module with respect to the battery module to be adjusted.

2. The apparatus of claim 1, wherein the wireless electronic module is a camera module.

3. The apparatus of claim 1, wherein the wireless electronic module is a camera module, and wherein the apparatus is configured to provide for tilting of the camera module and 360° rotation of the camera module around a power module central axis.

4. The security camera of claim 1, wherein the wireless electronic module comprises a hemispherical surface.

5. The security camera of claim 1, wherein the magnetic coupling provides a concave socket to receive the wireless electronic module.

6. The security camera of claim 1, wherein the wireless electronic module is a security camera, further comprising a mount for mounting the security camera to a wall or ceiling such that the security camera is substantially hidden from view.

7. The security camera of claim 6, wherein the mount comprises a cylindrical drywall anchor and an interface module that attaches to the cylindrical drywall anchor.

8. The security camera of claim 6, wherein the interface module houses the magnetic coupling.

9. The security camera of claim 1, wherein the wireless electronic module is a security camera configured to, during operation, rest on a horizontal surface in a standalone configuration.

10. A method of user interface for a wireless security camera system, comprising:
displaying a live view in which live video from one or more security cameras is displayed;
receiving a selection from a user selecting one of the one or more security cameras; and
in response to the selection, displaying multiple still images from a selected one of the one or more security cameras, separated in time.

11. The method of claim 10, wherein the multiple still images are still images that have been selected based on at least one of audio analysis and video analysis.

12. The method of claim 11, comprising providing automated alerts to the user based on at least one of audio analysis and video analysis.

13. The method of claim 12, comprising soliciting and receiving from the user feedback concerning the automated alerts, to conform the automated alerts more closely to preferences of the user.

14. A method of achieving flush mount of an electronic device, comprising:
installing a socket so as to be recessed in relation to a ceiling or wall, the socket being configured to provide both mechanical and electrical connection to an electronic module by insertion of the electronic module into the socket;
inserting the electronic module into the socket; and
manually adjusting a pointing direction of the electronic module.

15. A socket for providing mechanical and electrical connection to an electronic module, comprising:
a concave hemispherical surface;
a plurality of resilient electrical connectors that, when an electronic module is inserted in contact with the concave hemispherical surface, experience a force urging them into contact with a surface of the electronic module; and
at least one magnet for providing mechanical connection of the electronic module through attraction of the magnet.

16. An electronic module comprising:
a hemispherical surface;
a conducting contact area formed on the hemispherical surface;
electronic circuitry powered through the conducting contact area; and
at least one magnet for providing mechanical connection of the electronic module, including connection of the conducting contact area, through attraction of the magnet.
